(19) United States
(12) Patent Application Publication
(10) Pub. No.: US 2005/0179251 A1
(43) Pub. Date: Aug. 18, 2005

(54) Distribution of sporting or event schedules with business machine receipt paper

(75) Inventors: Lee O. Wagoner, Springboro, OH (US); David R. Preising, Oviedo, FL (US)

Correspondence Address: WEGMAN, HESSLER & VANDERBURG, 6055 ROCKSIDE WOODS BOULEVARD, SUITE 200, CLEVELAND, OH, 44131, US

(73) Assignee: Paper Systems Incorporated, Springboro, OH (US)

(21) Appl. No.: 11/037,434

(22) Filed: Jan. 18, 2005

Related U.S. Application Data
(60) Provisional application No. 60/538,955, filed on Jan. 23, 2004.

(51) Int. Cl. G09F 19/00; B41J 15/02

(52) U.S. Cl. 283/60.1; 283/56; 400/611

(57) ABSTRACT

A sporting or event schedule distribution medium is used with a printing device at a business machine terminal. A receipt paper is configured to be received by the printing device, the receipt paper has a first side on which transaction information is printed by the printing device, and a second side having a sporting or event schedule printed thereon.

### CROSS REFERENCE TO RELATED APPLICATION

This application claims the priority benefit of U.S. Provisional Patent Application Ser. No. 60/538,955 filed Jan. 23, 2004.

### BACKGROUND OF THE INVENTION

1. Field of Invention

This invention relates to distribution of sporting or event schedules, and, more specifically, to methods and systems for distributing printed sporting or event schedules on receipt paper at business machine terminals.

2. Description of Related Art

Today's society is convenience oriented society is marked with self service ATMs, pay-at-the pump gas stations, and self-service kiosk. Customers are constantly receiving receipts or ticket from business machine terminals. While it is known to provide coupons and store advertisement information on the backside of receipts, the backside of receipts are largely untapped as a medium for distributing information.

### SUMMARY OF THE INVENTION

The invention is accordingly directed to a method and system for distributing sporting and event schedules on business machine receipt paper. According to one embodiment, the invention is a sporting or event schedule distribution medium for use with a printing device of a business machine terminal. A receipt paper is configured to be received by the printing device, the receipt paper having a first side on which transaction information is printed by the printing device, and a second side having a sporting or event schedule printed thereon.

Another embodiment of the invention is a method for distributing sports or event schedules using business machine receipt paper. The method includes printing a sports or event schedule on one side of a receipt paper. The method further includes placing the receipt paper in a business machine terminal and printing transaction receipt information on an opposite side of the receipt paper at the business machine terminal. The receipt paper is distributed to the customer with the transaction information and the sports or event schedule.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of the systems and methods of this invention will be described in detail with reference to the following figures, wherein:

FIG. 1 is a perspective view of a receipt paper roll in accordance with the invention; and

FIG. 2 is a perspective view of another embodiment of a receipt paper roll in accordance with the invention.

### DETAILED DESCRIPTION OF EXEMPLARY EMBODIMENTS

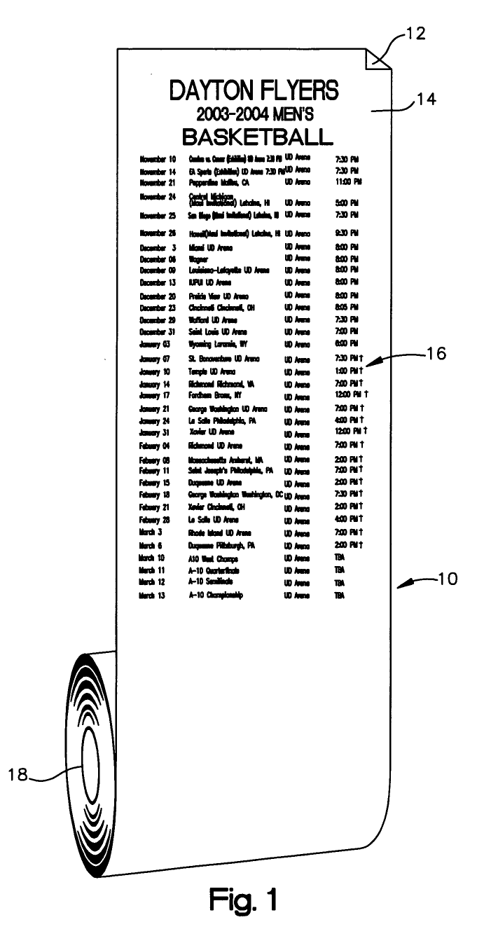

The invention will now be described with reference to the drawings. FIG. 1 illustrates one exemplary embodiment of business machine terminal receipt or ticket paper, broadly printing paper 10, for use as a sporting or event schedule distribution medium. In the example shown in FIG. 1, the receipt paper 10 is in roll form and designed to be used in a conventional printing device (not shown) in business machine terminals, such as point-of sale (“POS”) or service terminals. However, the receipt paper 10 can be manufactured as individual sheets of receipt paper without departing from the scope of the invention. As is customary, the receipt paper 10 is used by the printing device at business machine terminals to produce transaction receipts or tickets. Examples of receipts and tickets include, but are not limited to, POS receipts, ATM receipts, self-service kiosk receipts, coupons, pay-at-the-pump gas station receipts, credit card printer receipts, lottery and wagering tickets, event tickets, theater tickets, transportation tickets, and the like. Printing devices used at such business machine terminals are well known in the art and will not be described herein.

As shown, the roll of receipt paper 10 has a first side 12 that is suitably either free of printed material or contains faint background or boarder patterns on which the printing device imprints sales transaction information, ticket information, or the like. After the printing device has printed the sales transaction or ticket information on the first side 12 of the receipt paper 10, the portion of the receipt paper comprising the transaction receipt or ticket is torn, cut, or otherwise separated from the roll and distributed to the customer.

According to the invention, a second side 14 of the receipt paper 10 comprises a sporting or event schedule 16 printed thereon. Desirably, the sporting or event schedule 16 is pre-printed on the receipt paper 10 before the paper is inserted into the printing device and used at the business machine terminal to print a receipt. Sporting or event schedules 16 may include those for amateur and professional sports including, but not limited to, baseball, basketball, football, soccer, golf, auto racing, hockey, tennis, bowling, wrestling, track, swimming, volleyball, horse racing, sailing, and the like as well as those for concert tours, movie show times, and other events. As one skilled in the art will understand, the sporting or event schedule may be printed on the receipt paper 10 using any known printing process, such as, but not limited to, using offset, gravure, relief, or flexographic presses, or combinations of various printing processes.

The receipt paper 10 suitably has a width between about 20 millimeters (“mm”) and about 200 mm, and more desirably between about 28 mm and about 115 mm, although other widths are contemplated without departing from the scope of the invention. Desirably, after printing the sporting or event schedule 16 on the receipt paper 10, the paper is rolled about a core 18 using conventional means to provide a roll of receipt paper having a suitable length as is common in the industry. The receipt paper 10 can be manufactured from various types of paper or synthetic media such as Mylar, Tyvec®, poly and the like. As one skilled in the art will understand, the receipt paper 10 can be coated or uncoated depending on the type of the printing device in which it is to be used.

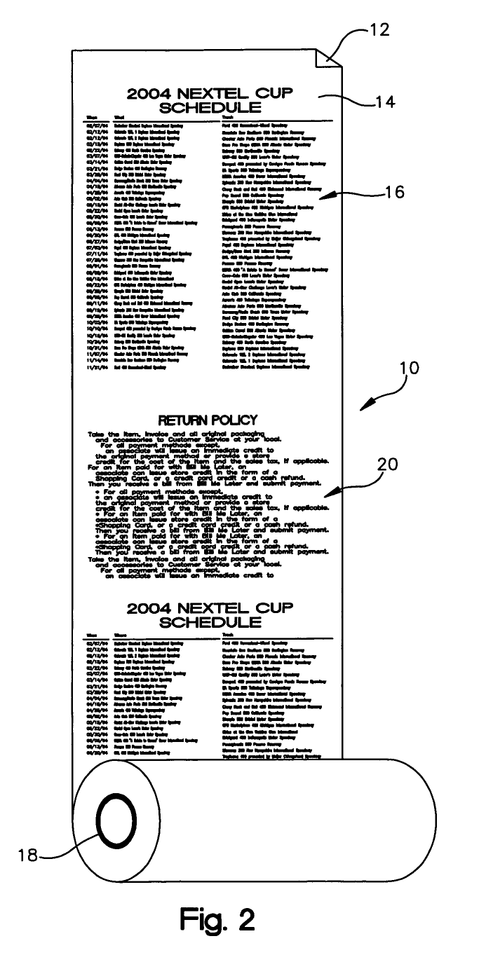

FIG. 2 illustrates another exemplary receipt paper 10, also in roll form, to be used as a POS receipt in which the second side 14 of the receipt paper 10 is also printed with logos, customer return policies, other business locations, product coupons and the like, indicated generally at 20, in addition to the sporting or event schedule 16. In the illustrated example, the receipt paper 10 is printed with sporting or event schedules 16 with a customer return policy 20 interspaced between the schedules. After every transaction at the place of business, the customer receives a receipt containing all or part of the sporting or event schedule 16 and the customer return policy 20.

While various exemplary embodiments of the invention are described herein, the invention is not limited to the precise forms of the receipt paper and methods described herein. It is evident based on the description provided that many changes, alterations, variations and changes to the invention can be made without departing from the scope of the invention as set forth herein.

1. A sporting or event schedule distribution medium for use with a printing device at a business machine terminal comprising a receipt paper configured to be received by said printing device, the receipt paper having a first side on which transaction information is printed by said printing device, and a second side having a sporting or event schedule printed thereon.

2. A sporting or event schedule distribution medium as recited in claim 1 wherein the receipt paper is a roll of receipt paper.

3. A sporting or event schedule distribution medium as recited in claim 1 wherein the sporting or event schedule is pre-printed on the second side before the receipt paper is received by said printing device.

4. A method for distributing sports or event schedules using business machine receipt paper comprising:
printing a sports or event schedule on one side of a receipt paper;
placing said receipt paper in a business machine terminal;
printing transaction receipt information on an opposite side of the receipt paper at said business machine terminal; and
distributing said receipt paper with said transaction information and said sports or event schedule to a customer of said business machine.
